(19) United States
(12) Patent Application Publication
(10) Pub. No.: US 2015/0057584 A1
(43) Pub. Date: Feb. 26, 2015

(54) Sole Acupoint Pressure Massage Apparatus

(71) Applicant: Jue-Yao Chen, CHANGHUA COUNTY (TW)

(72) Inventor: Jue-Yao Chen, CHANGHUA COUNTY (TW)

(21) Appl. No.: 13/973,020

(22) Filed: Aug. 22, 2013

(51) Int. Cl. A61H 39/04; A61H 15/00

(52) U.S. Cl. CPC A61H 39/04; A61H 15/0078; A61H 2230/85; A61H 2201/1207; A61H 2205/12
USPC 601/99

(57) ABSTRACT

A sole acupoint pressure massage apparatus includes a base. The base has therein a mechanism lower cover engaged therewith. The mechanism lower cover has therein a first power device and a second power device. A mechanism upper cover is disposed on the mechanism lower cover. A wavy wheel is pivotally disposed on the mechanism upper cover. A needle disk is disposed on the wavy wheel. An upper cover is disposed above the needle disk and coupled to the base. Needles are disposed on the needle disk. A first power device drives the wavy wheel to rotate. The wavy surface of the wavy wheel presses against the needles to massage sole acupoints. The second power device lifts the mechanism upper cover and drives the wavy wheel and the needles, thereby causing the needles to perform pressure massage on the sole.

### BACKGROUND OF THE INVENTION

1. Technical Field

The present invention relates to massage apparatuses, and more particularly, to a sole acupoint pressure massage apparatus characterized by a wavy wheel for driving all needles to perform acupoint massage on a sole and further characterized by a second power device for lifting all needles to perform pressure massage on the sole.

2. Description of Related Art

Conventional massage apparatuses are targeted at each portion of the human body. For example, some massage apparatuses are designed for waist and abdomen massage, whereas some massage apparatuses are designed for back massage or neck massage. Of course, there are also massage apparatuses designed for foot massage. As regards foot massage, it is focused on sole massage for two reasons. First, the sole has plenty of acupoints. Second, the sole is not only relatively flat but also relatively easy to massage.

The conventional sole massage apparatuses are not equipped with any pressing components; as a result, users must stand on the conventional sole massage apparatuses to press the acupoints of the users' soles by the users' body weight and thereby render sole massage effective. Nonetheless, not only is it exhausting for the users to be standing all the time, but sole massage also takes time to be beneficial to health. For these reasons, sole massage performed by the conventional sole massage apparatuses is inevitably inefficient. Accordingly, it is imperative that users receiving sole massage sit comfortably and still generate sufficient pressure to press sole acupoints.

### SUMMARY OF THE INVENTION

It is an objective of the present invention to provide a sole acupoint pressure massage apparatus characterized in that: a first power device drives a wavy wheel to rotate; the wavy wheel drives needles to perform acupoint massage on the sole; and a second power device lifts the wavy wheel and the needles to perform pressure massage on the sole.

In order to achieve the above and other objectives, the present invention provides a sole acupoint pressure massage apparatus, comprising a base. The base has therein a mechanism lower cover engaged therewith. The mechanism lower cover has therein a first power device and a second power device. A mechanism upper cover is disposed on the mechanism lower cover. A wavy wheel is pivotally disposed on the mechanism upper cover. A needle disk is disposed on the wavy wheel. An upper cover is disposed above the needle disk and coupled to the base. Needles are disposed on the needle disk. A first power device drives the wavy wheel to rotate. The wavy surface of the wavy wheel presses against the needles to massage sole acupoints. The second power device lifts the mechanism upper cover and drives the wavy wheel and the needles, thereby causing the needles to perform pressure massage on the sole.

### BRIEF DESCRIPTION OF THE DRAWINGS

FIG. 1 is a schematic exploded view of a sole acupoint pressure massage apparatus according to an embodiment of the present invention;

FIG. 2 is a partial schematic exploded view of the sole acupoint pressure massage apparatus according to the embodiment of the present invention;

FIG. 3 is a schematic perspective view of the sole acupoint pressure massage apparatus according to the embodiment of the present invention;

FIG. 4 is a schematic front cross-sectional view of the sole acupoint pressure massage apparatus according to the embodiment of the present invention;

FIG. 5 is a schematic lateral cross-sectional view of the sole acupoint pressure massage apparatus according to the embodiment of the present invention;

FIG. 6 is a partial cross-sectional view of the sole acupoint pressure massage apparatus according to the embodiment of the present invention;

FIG. 7 is another partial cross-sectional view of the sole acupoint pressure massage apparatus according to the embodiment of the present invention; and

FIG. 8 is a schematic view of performing sole acupoint pressure massage on a user sitting comfortably with the sole acupoint pressure massage apparatus according to the embodiment of the present invention.

### DETAILED DESCRIPTION OF THE EMBODIMENT OF THE INVENTION

The present invention provides a sole acupoint pressure massage apparatus.

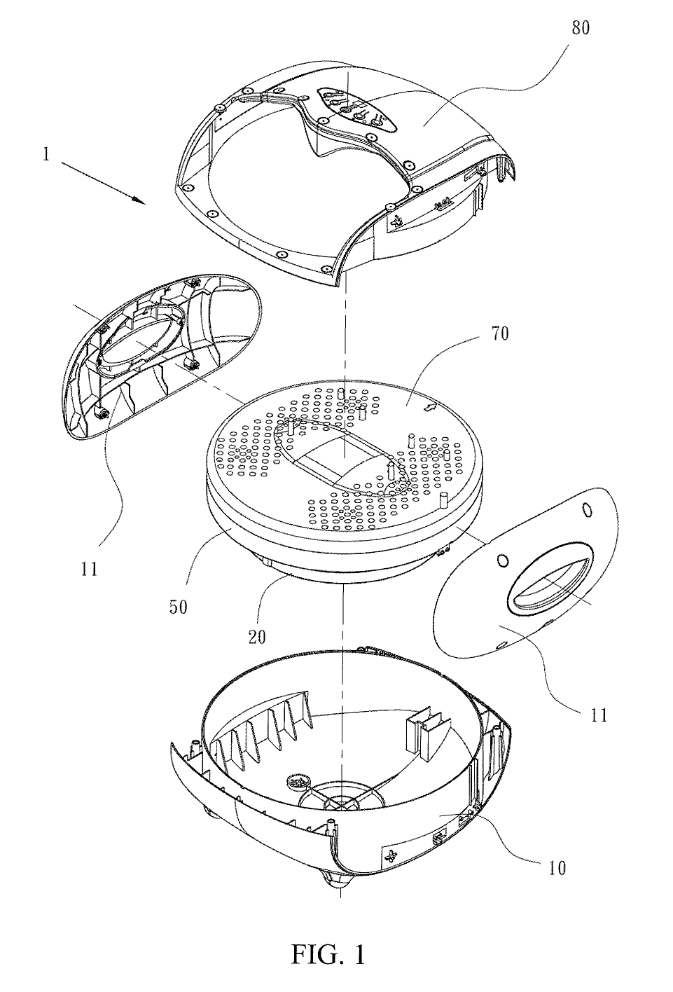

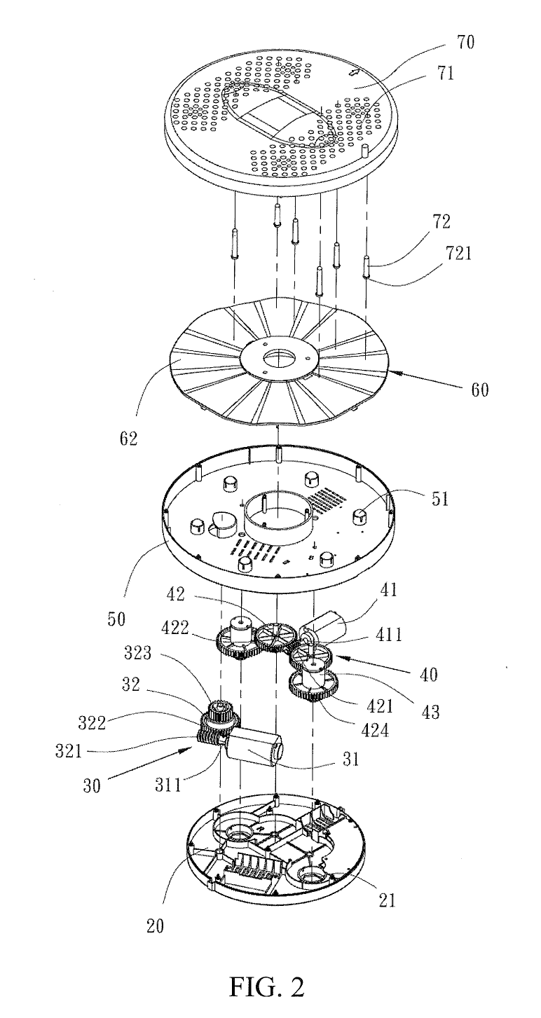

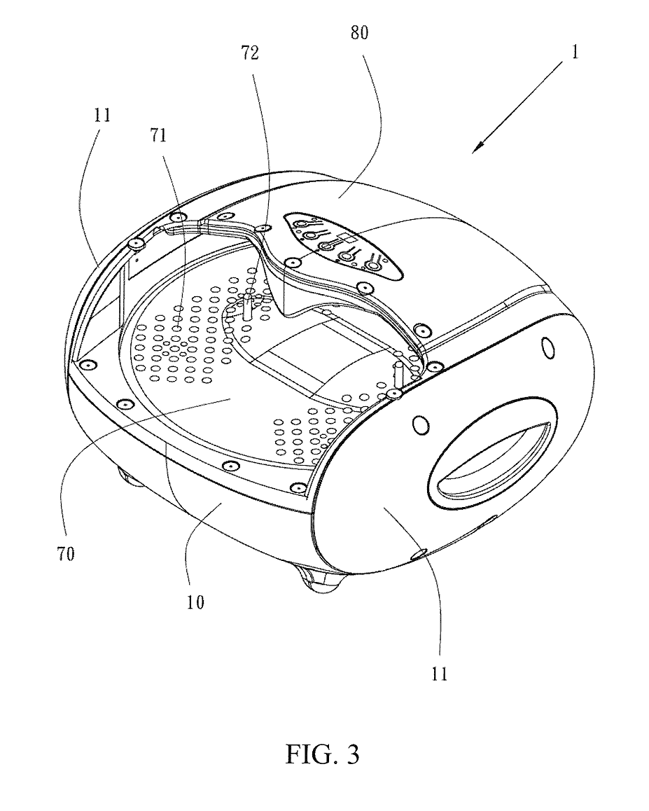

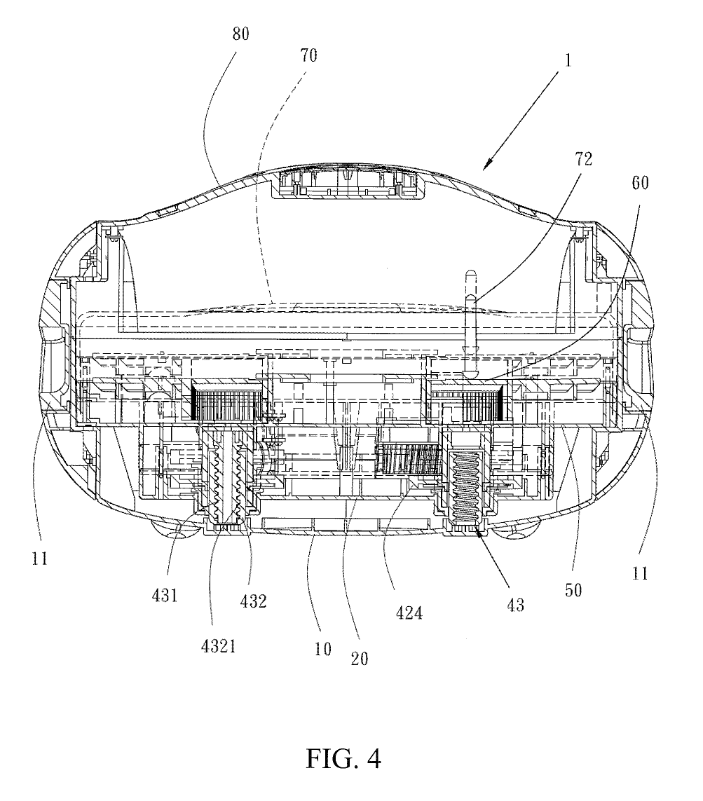

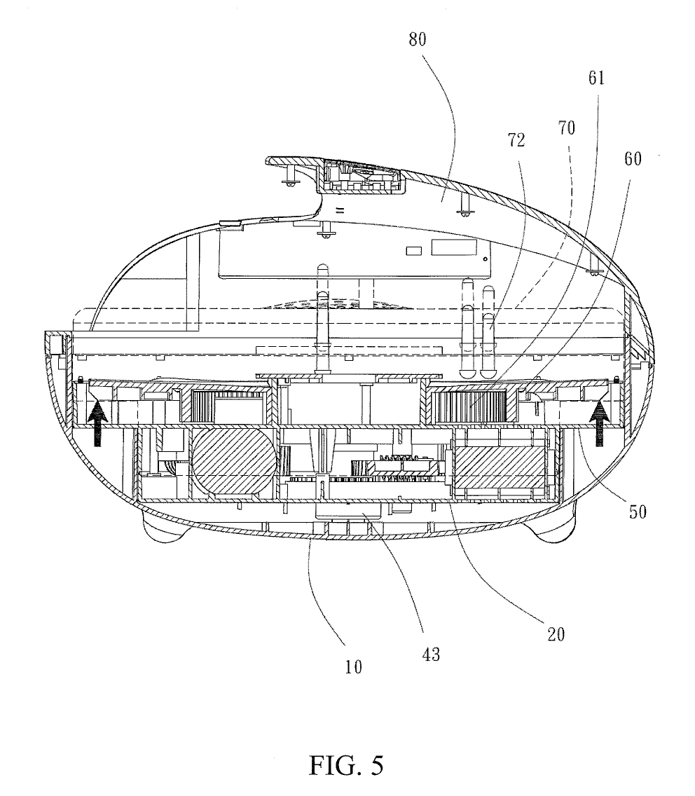

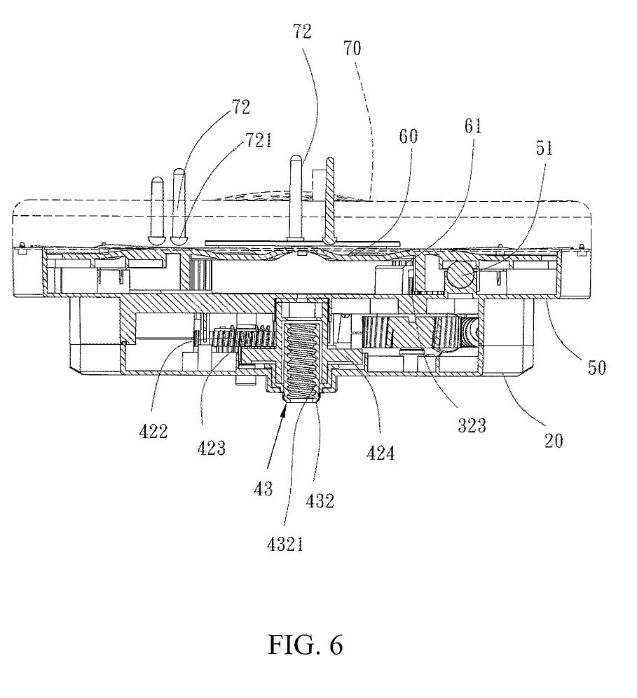

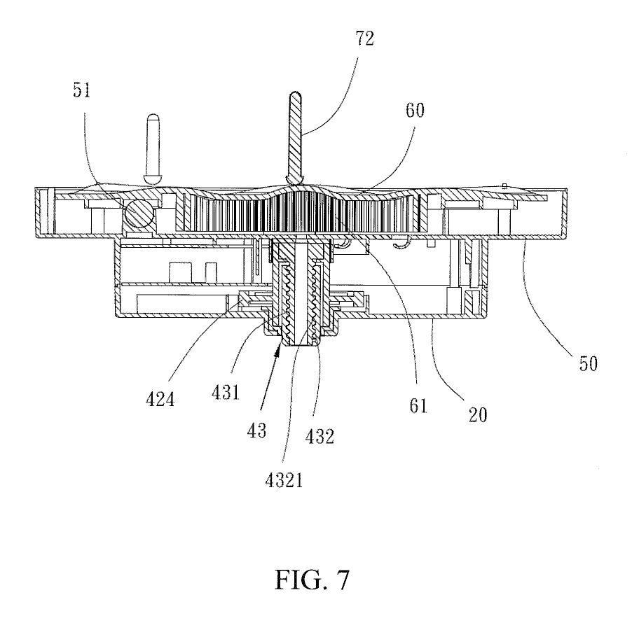

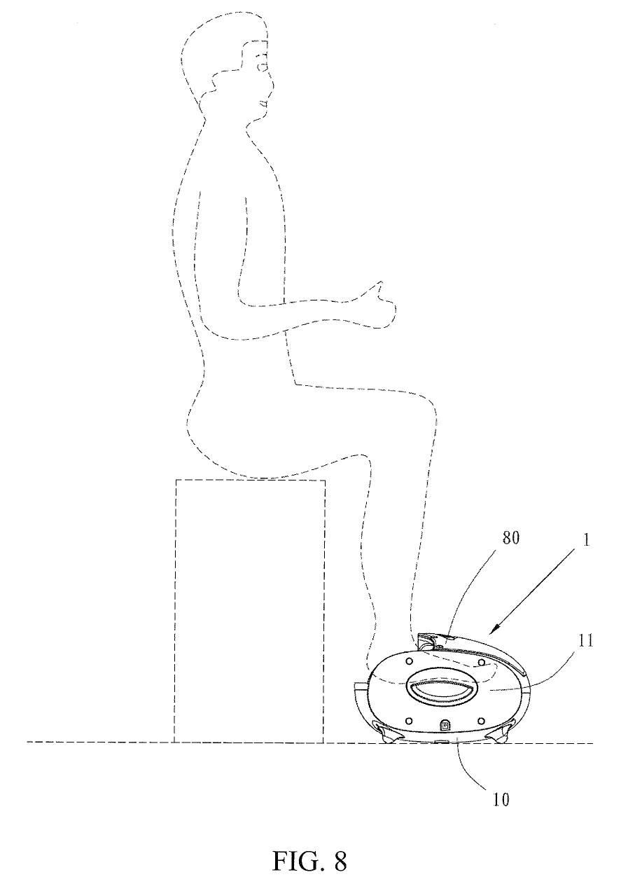

Referring to FIG. 1 through FIG. 8, the present invention provides a sole acupoint pressure massage apparatus 1 comprising a base 10, a mechanism lower cover 20, a first power device 30, a second power device 40, a mechanism upper cover 50, a wavy wheel 60, a needle disk 70, and an upper cover 80.

The base 10 is flanked by two side covers 11 fixed thereto.

The base 10 has therein the mechanism lower cover 20 engaged therewith.

The first power device 30 comprises a first motor 31 for driving a first gear set 32.

The mechanism lower cover 20 has therein the first power device 30 and the second power device 40. The second power device 40 comprises a second motor 41 for driving at least a second gear set 42. The at least a second gear set 42 drives at least an elevation assembly 43.

The mechanism upper cover 50 is disposed on the mechanism lower cover 20.

The wavy wheel 60 is pivotally disposed on the mechanism upper cover 50. An annular inner rack 61 is disposed on the bottom surface of the wavy wheel 60. The first gear set 32 penetrates the mechanism upper cover 50 and protrudes therefrom to cause the first gear set 32 to mesh with the annular inner rack 61 and thereby drive the wavy wheel 60 to rotate.

The needle disk 70 is disposed on the wavy wheel 60 and fixed to the mechanism upper cover 50. Through-holes 71 are disposed on the surface of the needle disk 70 and distributed to form thereon a pattern which matches a pair of soles of the average human being in outline. The through-holes 71 are each penetrable by a needle 72. The needles 72 come in the following categories by length, namely long needles 72, medium needles 72, and short needles 72, which are applicable as needed. The bottom 721 of each said needle 72 abuts against a wavy surface 62 of the wavy wheel 60, such that the needles 72 move vertically and wavily to abut against sole acupoints.

The upper cover 80 is disposed above the needle disk 70 and coupled to the base 10, so as to finalize the assembly of the sole acupoint pressure massage apparatus 1, allow the upper cover 80 to press against the metatarsus, and enable the at least an elevation assembly 43 of the second power device 40 to lift the mechanism upper and lower covers 50, 20, the wavy wheel 60, the needle disk 70, and the needles 72 for performing pressure massage on the sole in a manner for pressure to be transferred from the tips of the needles 72 to the acupoints in the sole.

As regards the sole acupoint pressure massage apparatus, the first power device 30 comprises a first motor 31 for driving the first gear set 32. The first gear set 32 comprises a first worm gear 321 fixed to a spindle 311 of the first motor 31. The first worm gear 321 meshes with a first gear 322. The first gear 322 and a second gear 323 are integrally formed as a unitary structure. The second gear 323 meshes with the annular inner rack 61 of the wavy wheel 60 and thereby drives the wavy wheel 60 to rotate.

As regards the sole acupoint pressure massage apparatus, the second power device 40 comprises the second motor 41 for driving the at least a second gear set 42. The at least a second gear set 42 drives the at least an elevation assembly 43. The at least a second gear set 42 comprises a second worm wheel 421 fixed to a spindle 411 of the second motor 41. The second worm wheel 421 meshes with a third gear 422. A fourth gear 423 and the third gear 422 are integrally formed as a unitary structure. A fifth gear 424 meshes with the fourth gear 423. The fifth gear 424 is fixed integrally to the top end of an elevation worm screw 431 of the at least an elevation assembly 43. An internal thread 4321 is disposed in a securing pipe 432 of the at least an elevation assembly 43 and adapted to mesh with the elevation worm screw 431. The bottom of the securing pipe 432 protrudes from the mechanism lower cover 20 to abut against the base 10. The securing pipe 432 is circumferentially non-round and capable of penetrating at least one non-round hole 21 penetratingly disposed on the mechanism lower cover 20 to ensure that the securing pipe 432 is incapable of rotation, such that the elevation worm screw 431 enters a motion mode of rotational ascent or rotational descent as soon as the fifth gear 424 and the elevation worm screw 431 rotate.

As regards the sole acupoint pressure massage apparatus, abrasion resistant balls 51 are equidistantly spaced apart and disposed between the top surface of the mechanism upper cover 50 and the bottom surface of the wavy wheel 60 to abut against the bottom surface of the wavy wheel 60, such that the wavy wheel 60 bears the body weight of a user and is still rotating.

As regards the sole acupoint pressure massage apparatus, the user can put his or feet in the space defined by the upper cover 80 and the needle disk 70 in a manner that the soles are completely positioned on the needle disk 70 to allow the needles 72 to abut against the soles. As soon as the first power device 30 drives the wavy wheel 60 to rotate, the needles 72 are driven by the wavy surface 62 to move vertically and wavily to abut against sole acupoints. With the sole acupoint pressure massage apparatus pressing the soles, the user need not stand in order to have the soles massaged; instead, the user sits comfortably while receiving sole acupoint pressure massage, as the second power device 40 drives the mechanism upper and lower covers 50, 20, the wavy wheel 60, the needle disk 70, and all the needles 72 to ascend, such that ascent-induced pressure is transmitted from the top ends of the needles 72 to the acupoints at the soles, thereby effectuating sole acupoint massage.

Therefore, the sole acupoint pressure massage apparatus of the present invention is novel and thus meets the novelty requirement of patentability. Furthermore, the sole acupoint pressure massage apparatus of the present invention is extensively innovative and thus meets the inventiveness requirement of patentability. Furthermore, the sole acupoint pressure massage apparatus of the present invention is characterized by a wavy wheel for driving needles to perform acupoint massage on the soles, and characterized by a second power device for lifting the needles, such that the needles perform pressure massage on the soles; hence, the sole acupoint pressure massage apparatus of the present invention has industrial applicability.

What is claimed is:

1. A sole acupoint pressure massage apparatus, comprising:
a base;
a mechanism lower cover, wherein the base has therein the mechanism lower cover engaged therewith;
a first power device comprising a first motor for driving a first gear set;
a second power device, wherein the mechanism lower cover has therein the first power device and the second power device, the second power device comprising a second motor for driving at least a second gear set, the at least a second gear set driving at least an elevation assembly;
a mechanism upper cover disposed on the mechanism lower cover;
a wavy wheel pivotally disposed on the mechanism upper cover, wherein an annular inner rack is disposed beneath the wavy wheel, and the first gear set penetrates the mechanism upper cover and protrudes therefrom to allow the first gear set to mesh with the annular inner rack and thereby drive the wavy wheel to rotate;
a needle disk disposed on the wavy wheel and fixed to the mechanism upper cover, wherein through-holes are disposed on a surface of the needle disk and distributed to form thereon a pattern which matches a pair of soles of the average human being in outline, each said through-hole being penetrable by a needle, wherein a bottom of each said needle abuts against a wavy surface of the wavy wheel, such that the needles move vertically and wavily to abut against sole acupoints; and
an upper cover disposed above the needle disk and coupled to the base, so as to finalize assembly of the sole acupoint pressure massage apparatus, allow the upper cover to press against the metatarsus, and enable the at least an elevation assembly of the second power device to lift the mechanism upper and lower covers, the wavy wheel, the needle disk, and the needles for performing pressure massage on the sole in a manner for pressure to be transferred from the tips of the needles to the acupoints in the sole.

2. The sole acupoint pressure massage apparatus of claim 1, wherein the base is flanked by two side covers fixed thereto.

3. The sole acupoint pressure massage apparatus of claim 1, wherein the needles comprise long needles, medium needles, and short needles which are applicable as needed.

4. The sole acupoint pressure massage apparatus of claim 1, wherein the first power device comprises a first motor for driving the first gear set, the first gear set comprising a first worm gear fixed to a spindle of the first motor, the first worm gear meshing with a first gear, wherein the first gear and a second gear are integrally formed as a unitary structure, the second gear meshing with the annular inner rack of the wavy wheel to thereby drive the wavy wheel to rotate.

5. The sole acupoint pressure massage apparatus of claim 1, wherein the second power device comprises the second motor for driving the at least a second gear set, the at least a second gear set driving the at least an elevation assembly, the at least a second gear set comprising a second worm wheel fixed to a spindle of the second motor, the second worm wheel meshing with a third gear, wherein a fourth gear and the third gear are integrally formed as a unitary structure, the fourth gear meshing with a fifth gear, the fifth gear being fixed integrally to a top end of an elevation worm screw of the at least an elevation assembly, wherein an internal thread is disposed in a securing pipe of the at least an elevation assembly and adapted to mesh with the elevation worm screw, and a bottom of the securing pipe protrudes from the mechanism lower cover to abut against the base, the securing pipe being circumferentially non-round and capable of penetrating at least a non-round hole penetratingly disposed on the mechanism lower cover to ensure that the securing pipe is incapable of rotation, such that the elevation worm screw enters a motion mode of rotational ascent or rotational descent as soon as the fifth gear and the elevation worm screw rotate.

6. The sole acupoint pressure massage apparatus of claim 1, wherein abrasion resistant balls are equidistantly spaced apart and disposed between a top surface of the mechanism upper cover and a bottom surface of the wavy wheel to abut against the bottom surface of the wavy wheel such that the wavy wheel bears body weight of a user and is still rotating.
